(19) United States
(12) Patent Application Publication
(10) Pub. No.: US 2025/0310381 A1
(43) Pub. Date: Oct. 2, 2025

(54) METHOD, APPARATUS, SYSTEM, AND COMPUTER PROGRAM FOR AUTOMATICALLY GENERATING INTER-SERVICE COMMUNICATION SECURITY POLICIES IN REAL TIME

(71) Applicant: SAMSUNG SDS CO., LTD., Seoul (KR)

(72) Inventors: Beumjin CHO, Seoul (KR); Nam Sik HAM, Seoul (KR); Huey JEONG, Seoul (KR); Yoonchan JHI, Seoul (KR); Jihoon CHO, Seoul (KR)

(73) Assignee: SAMSUNG SDS CO., LTD., Seoul (KR)

(21) Appl. No.: 19/090,570

(22) Filed: Mar. 26, 2025

(30) Foreign Application Priority Data
Mar. 28, 2024 (KR) 10-2024-0042333
Jul. 18, 2024 (KR) 10-2024-0094903

(51) Int. Cl. H04L 9/40; G06F 9/54

(52) U.S. Cl. CPC H04L 63/20; G06F 9/547

(57) ABSTRACT

A method, apparatus, system, and computer program that automatically generates an inter-service communication security policy in real time is provided. More specifically, a method that automatically generates a communication security policy among multiple services constituting an application running in a cloud system using a computing device includes collecting an application programming interface (API) remote call list for related services of a first service among the multiple services; configuring a first prompt, based on the remote call list; and generating a first security policy for a remote call of the first service by implementing an artificial intelligence model, based on the first prompt.

### CROSS-REFERENCE TO RELATED APPLICATIONS

This application is based on, and claims the benefit under 35 U.S.C. 119 of, Korean Patent Application No. 10-2024-0042333, filed on Mar. 28, 2024, and Korean Patent Application No. 10-2024-0094903, filed on Jul. 18, 2024, in the Korean Intellectual Property Office, the entire disclosures of which are herein incorporated by reference for all purposes.

### BACKGROUND

### 1. Field

The following description relates to a method, apparatus, system, and computer program that automatically generates an inter-service communication security policy in real time and, more specifically, to a method, apparatus, system, and computer program for generating an inter-service communication security policy that automatically generates and applies a security policy that enables communication among multiple services constituting an application in real time.

### 2. Description of Related Art

Recently, various applications have been provided based on online environments, and environments that provide applications have been rapidly spreading, based on cloud systems such as Kubernetes.

In this regard, in typical cloud environments such as Kubernetes, a proxy module that provides network operations or the like may be placed at the front or middle of the workload for inter-service access control between services constituting the application, and a service mesh (e.g., istio, etc.) may be used so that a controller is able to distribute and manage policies, and at this time, the respective services operate in a remote procedure call (RPC) manner in which the API is remotely called.

However, recently, in line with the increase in the size of applications and the generalization of cloud systems, environments in which development and operation are performed in units of multiple micro-services constituting applications have been spreading, and furthermore, separation of application development from operations have led to frequent cases in which developers who develop APIs and cluster operators who run micro-services are different.

Accordingly, in the past, it took a lot of time and manpower for the operator to identify the relationships among multiple micro-services and write and apply a security policy, and security risks increased due to human errors that may occur during the manual process.

Furthermore, in recent applications running in a cloud environment, the frequent addition, deletion, and update of multiple micro-services have caused problems such as rapid increases in security operation difficulties and security risks for the operator.

Accordingly, there is a need for a method that efficiently identifies the relationships among multiple micro-services constituting the application and writing and applies a security policy to suppress security risks, and that effectively resolves the security operation difficulties and security risks of the operator due to the addition, deletion, and update of multiple micro-services, but no appropriate solution has been presented yet.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a processor-implemented method that automatically generates a communication security policy among multiple services constituting an application running in a cloud system with a computing device includes collecting an application programming interface (API) remote call list for related services of a first service among the multiple services; configuring a first prompt, based on the remote call list; and generating a first security policy for a remote call of the first service by implementing an artificial intelligence model, based on the first prompt.

The method may further include generating the application programming interface (API) remote call list for the related services by performing static analysis of source code of the first service.

The collecting may include deploying a first workload in which the first service is operated; collecting the remote call list for the related services of the first service; and collecting metadata about a workload in which the multiple services are operated in the cloud system.

The collecting may include collecting metadata about related services that are remotely called by the first service.

The method may further include applying the first security policy to a second workload in which a second service that is remotely called by the first service is operated, to control a remote call from the first service.

The method may further include deploying and applying the first security policy to the second workload in real time when the first workload in which the first service is operated is deployed.

The method may further include applying the first security policy to a proxy device corresponding to the second workload.

The configuring of the first prompt may include adding some or all of the content of the remote call list and the metadata to a predetermined prompt template, to configure the first prompt.

The configuring of the first prompt may include configuring the first prompt such that the pre-deployed security policy is included in the first prompt when there is a pre-deployed security policy corresponding to the first service, wherein the generating of the first security policy may include generating the first security policy by reflecting an updated security policy according to an update of the first service to the pre-deployed security policy.

In a general aspect, an apparatus that automatically generates a communication security policy among multiple services constituting an application running in a cloud system, includes one or more processors; and a memory storing instructions that, when executed by the one or more processors cause the apparatus to: collect an application programming interface (API) remote call list for related services of a first service among the multiple services; configure a first prompt, based on the remote call list; and generate a first security policy for a remote call of the first service by implementing an artificial intelligence model, based on the first prompt.

The one or more processors may be further configured to generate the application programming interface (API) remote call list for the related services by performing static analysis of source code of the first service.

The collecting may include deploying a first workload in which the first service is operated; collecting the remote call list for the related services of the first service; and collecting metadata about a workload in which the multiple services are operated in the cloud system.

In the collecting, metadata about related services that are remotely called by the first service may be collected.

The specific operations may further include applying the first security policy to a second workload in which a second service that is remotely called by the first service is operated, to control a remote call from the first service.

The first security policy may be deployed and applied to the second workload in real time when the first workload in which the first service is operated is deployed.

The first security policy may be applied to a proxy device corresponding to the second workload.

In the configuring of the first prompt, the first prompt may be configured by adding some or all of the content of the remote call list and the metadata to a predetermined prompt template.

In the configuring of the first prompt, the first prompt may be configured such that the pre-deployed security policy is included in the first prompt when there is a pre-deployed security policy corresponding to the first service, and in the generating of the first security policy, the first security policy may be generated by reflecting an updated security policy according to an update of the first service to the pre-deployed security policy.

In a general aspect, a non-transitory computer-readable storage medium storing instructions that, when executed by one or more processors, cause an apparatus that automatically generates a communication security policy among multiple services constituting an application running in a cloud system, to collect an application programming interface (API) remote call list for related services of a first service among the multiple services; configure a first prompt, based on the remote call list; and generate a first security policy for a remote call of the first service by implementing an artificial intelligence model, based on the first prompt.

The one or more processors may be further configured to generate the application programming interface (API) remote call list for the related services by performing static analysis of source code of the first service.

Other features and aspects will be apparent from the following detailed description, the drawings, and the claims.

### BRIEF DESCRIPTION OF DRAWINGS

FIG. 1 is a diagram illustrating the configuration of a security policy generating system, in accordance with one or more embodiments.

FIG. 2 is a flowchart illustrating a security policy generating method, in accordance with one or more embodiments.

FIG. 3 is a flowchart illustrating a specific flowchart of a collecting step of a security policy generating method, in accordance with one or more embodiments.

FIG. 4, FIG. 5, and FIG. 6 are diagrams illustrating a specific configuration and operation of a security policy generating system, in accordance with one or more embodiments.

FIG. 7 is a diagram illustrating a prompt generated by a security policy generating system, in accordance with one or more embodiments.

FIG. 8 is a diagram illustrating a first security policy generated by a security policy generating system, in accordance with one or more embodiments.

FIG. 9 is a diagram illustrating the configuration of a computing device that generates a security policy, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Hereinafter, one or more embodiments of a method, apparatus, system, and computer program that automatically generates an inter-service communication security policy in real time, in accordance with one or more embodiments, will be described in detail with reference to the attached drawings.

One or more examples may provide a method, apparatus, system, and computer program that generates an inter-service communication security policy that effectively identifies the relationships among multiple micro-services constituting an application and writes and applies a security policy to suppress security risks. One or more examples may also provide a method, apparatus, system, and computer program that generates an inter-service communication security policy that effectively resolves the security operation difficulties and security risks of the operator due to the addition, deletion, and update of multiple micro-services.

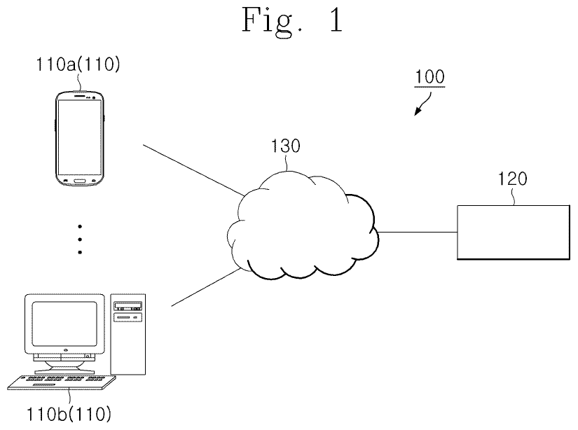

FIG. 1 illustrates the configuration and operation of a security policy generating system 100 according to an embodiment of the disclosure. As shown in FIG. 1, the security policy generating system 100, in accordance with one or more embodiments, may be configured to include one or more user terminals 110a and 110b and a security policy generating apparatus 120 that is configured generate a security policy for multiple services of a cloud-based application and deploy and apply the generated security policy.

In this case, various terminals such as personal computers (PCs), laptop PCs, tablet PCs, smartphones, PDAs, and the like may be used as the terminals 110a and 110b to allow users such as developers developing applications, operators operating developed applications, or application users using the application to input or provide information or requests for generating security policies for the application or using the application, but the disclosure is not necessarily limited thereto, and various other devices may be used as the terminals 110a and 110b.

In addition, the security policy generating apparatus 120 may be implemented using one or more physical server devices, but the disclosure is not necessarily limited thereto, and it may also be configured using personal computer processing devices such as desktop computers, laptops, tablets, or smartphones, or implemented in various forms such as dedicated devices.

Furthermore, the terminals 110a and 110b and the security policy generating apparatus 120 may be implemented to be combined as a single device or a server.

In addition, a wired network and a wireless network may be used as a network 130 connecting the terminals 110a and 110b and the security policy generating apparatus 120 in FIG. 1, and specifically, the network may include various communication networks such as a local area network (LAN), a metropolitan area network (MAN), and a wide area network (WAN). In addition, the network 130 may include the well-known World Wide Web (WWW). Furthermore, the network 130 may also be implemented using a data bus configured to transmit and receive data.

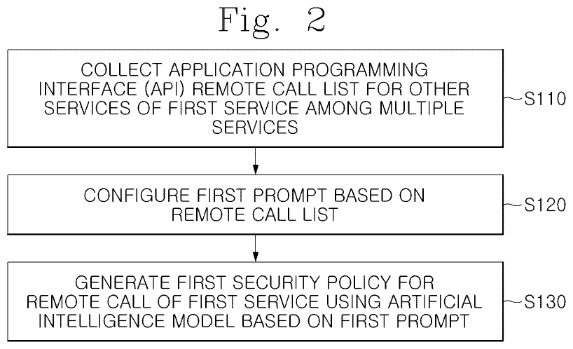

In addition, FIG. 2 illustrates a flowchart of a security policy generating method according to an embodiment of the disclosure.

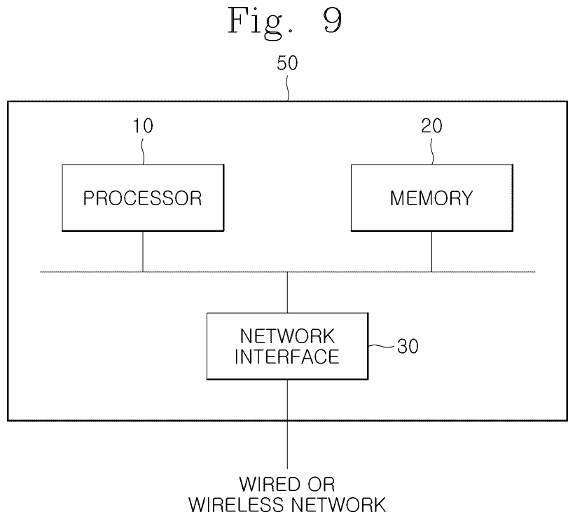

Here, the method illustrated in FIG. 2 may be performed by, for example, the security policy generating apparatus 120, and the security policy generating apparatus 120 may be implemented to include a computing device 50 in FIG. 9 and a description made below with reference to FIG. 9. For example, the security policy generating apparatus 120 may be provided with a processor 10, and the processor 10 may execute instructions configured to implement an operation that generates and provides a security policy for multiple services of an application running in a cloud.

More specifically, as shown in FIG. 2, a security policy generating method, in accordance with one or more embodiments, is a method of automatically generating a communication security policy among multiple services constituting an application running in a cloud system using a computing device 50, which may include an operation S110 of collecting an application programming interface (API) remote call list for other services of a first service among the multiple services, an operation S120 of configuring a first prompt, based on the remote call list, and an operation S130 of generating a first security policy for a remote call of the first service using an artificial intelligence model, based on the first prompt.

Here, the method may further include an operation (not shown) of generating the application programming interface (API) remote call list for other services through static analysis of source code of the first service.

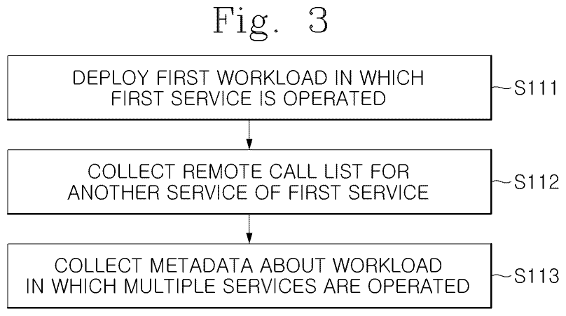

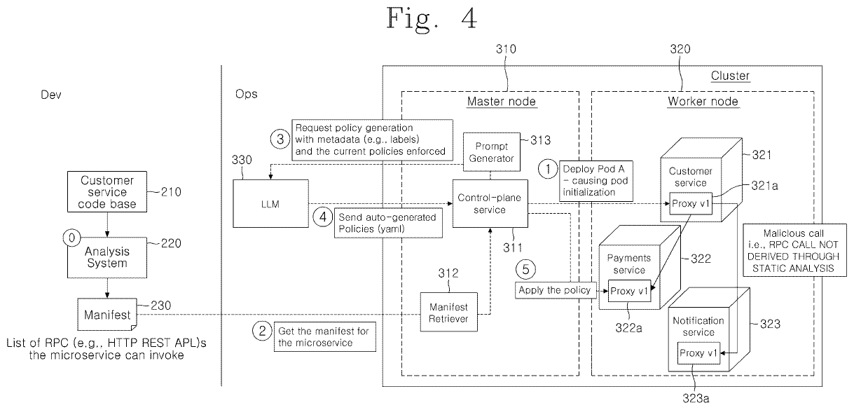

In addition, the operation S110 of collecting, as shown in FIG. 3, may include an operation S111 of deploying a first workload in which the first service is operated, an operation S112 of collecting a remote call list for other services of the first service, and an operation S113 of collecting metadata about a workload in which the multiple services are operated in the cloud system.

In addition, in the operation S110 of collecting, metadata about other services remotely called by the first service may be collected.

In addition, the method may further include an operation (not shown) of applying the first security policy to a second workload in which a second service remotely called by the first service is operated, thereby controlling a remote call from the first service.

In this case, in an example in which the first workload in which the first service is operated is deployed, the first security policy may be deployed and applied to the second workload in real time.

In addition, the first security policy may be applied to a proxy module corresponding to the second workload.

In addition, in the operation S120 of configuring, the first prompt may be configured by adding some or all of the content of the remote call list and the metadata to a predetermined prompt template.

In addition, in the operation S120 of configuring, in case that there is a pre-deployed security policy corresponding to the first service, the first prompt may be configured such that the pre-deployed security policy is included in the first prompt, and in the operation S130 of generating, the first security policy may be generated by reflecting the updated security policy according to the update of the first service to the pre-deployed security policy.

Accordingly, a method, apparatus, system, and computer program that generates an inter-service communication security policy, in accordance with one or more embodiments, may effectively identify the relationships among multiple services constituting an application and write and apply a security policy to suppress security risks, and may further effectively resolve the security operation difficulties and security risks of the operator due to the addition, deletion, and update of multiple services.

Hereinafter, the configuration and operation of an inter-service communication security policy generating method, apparatus, and system, in accordance with one or more embodiments, will be described in more detail with reference to the respective drawings.

First, in operation S110, the computing device 50 such as the security policy generating apparatus 120 collects an application programming interface (API) remote call list for other services of a first service among the multiple services constituting the application.

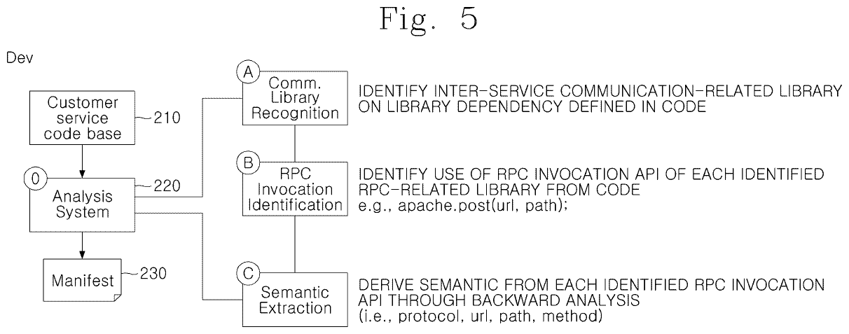

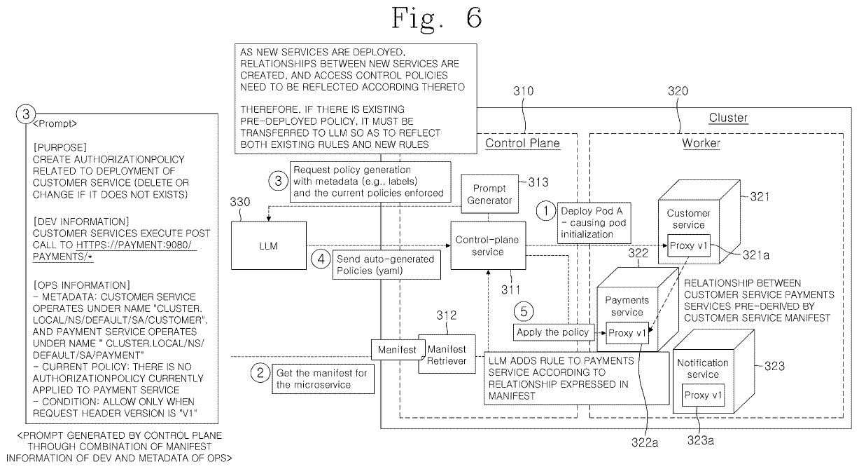

Accordingly, referring to FIG. 4, the security policy generating apparatus 120 may be implemented using a control-plane service 311 operated in a master node 310 of the cloud system, but the examples are not limited thereto, and the security policy generating apparatus 120 may be implemented in various ways, such as a separate dedicated device.

In this case, as shown in FIG. 4, in the control-plane service 311, in case that the first service among the multiple services constituting the application is new or updated and deployed in the form of a pod of the like ((1) in FIG. 4), the application programming interface (API) remote call list for other services generated through static analysis ((o) in FIG. 4) of the source code of the first service may be collected ((2) in FIG. 4).

Accordingly, in the examples, a first prompt to generate a security policy may be generated based on the remote call list for other services of the first service, and an artificial intelligence model such as a large language model (LLM) 330 may be requested to generate a first security policy for the first service (\textcircled{3} in FIG. 4), and the generated first security policy is received from the artificial intelligence model \textcircled{4} in FIG. 4), and may be applied to control a remote call for the first service \textcircled{5} in FIG. 4).

More specifically, as shown in FIG. 3, the operation S110 may include an operation S111 of deploying a first workload in which the first service is operated, an operation S112 of collecting a remote call list for another service of the first service, and an operation S113 of collecting metadata about a workload in which multiple services are operated in a cloud system.

In this case, in the inter-service communication security policy generating method, apparatus, and system according to an embodiment of the disclosure, the application may be configured as multiple services, and in this case, the multiple services may operate in a manner of remote procedure call (RPC) to remotely call the application programming interfaces (APIs) with each other.

As a more specific example, when developing a home shopping application, the application may be configured to include multiple services, such as a customer service that provides a user interface to customers, a payment service that processes payments, and a notification service that processes shopping-related notifications.

Here, although the application may be configured as multiple services on the basis of a Kubernetes environment or the like, the examples are not limited thereto, and in the case where the application is configured based on a microservice architecture or the like, the service may also include a micro-service, and furthermore, in the examples, the application may be configured to be divided as multiple services in various ways.

In this case, the method for generating an inter-service communication security policy, in accordance with one or more embodiments, may include, before the operation S110, an operation (not shown) of generating an application programming interface (API) remote call list for other services through static analysis of the source code of the first service.

For example, as shown in FIG. 4, when the source code 210 of the first service (e.g., the source code of the customer service in FIG. 4) is completed in the development process of the application (Dev, Development in FIG. 4), the source code 210 may be input into the analysis system 220 to perform static analysis ((0) in FIG. 4).

More specifically, referring to FIG. 5, when the analysis system 220 receives the source code 210 of the first service, the analysis system 220 may preferentially identify the library associated with inter-service communication, based on the library dependency defined in the source code ((a) in FIG. 5).

In addition, the analysis system 220 may identify the application programming interface (API) remote call code for the associated library identified from the source code 210 ((b) in FIG. 5).

Next, the analysis system 220 may derive information such as a protocol (e.g., “HTTPS” in FIG. 5), a uniform resource locator (URL) (e.g., “http://payment:9080/payments/*” in FIG. 5), a path (e.g., “payments/*” in FIG. 5), and a method (e.g., “POST” in FIG. 5) for each remote call through backward analysis based on the identified application programming interface (API) remote call code ((c) in FIG. 5).

In this case, in the disclosure, it is possible to identify which remote call (RPC) may be used to perform which operation when each service is operated through static analysis of the source code 210, and the remote calls (RPCs) derived through this may be treated as a normal call list (whitelist) that should be allowed when operated, and the remaining remote calls (RPCs) may be determined as abnormal calls and blocked through access control through security policy or the like, and through this, it is possible to collect respective manifest files 230 and identify the relationship among multiple services constituting the entire application based on this, thereby implementing a security policy based on zero-trust.

Accordingly, the analysis system 220 may identify a code to perform an application programming interface (API) remote call (RPC invocation) for other (or related) services (e.g., payment service or notification service) from the first service (e.g., customer service) through static analysis of the source code 210 and, based on this, generate a remote call list and store the same in the form of a manifest file 230.

In this case, the remote call list may include the entire enabling remote call in the first service.

However, the examples are not necessarily limited thereto, and the generation of a remote call list through static analysis of the source code 210 may be implemented in various ways, such as an operator generating a remote call list during an application operation process (Ops, Operations in FIG. 4) after the application development process (Dev in FIG. 4).

Next, in operation S111, the first workload in which the first service is operated may be deployed.

As a more specific example, as shown in FIG. 4, the control-plane service 311 operated on the master node 310 of the cloud system may deploy the first workload (321 in FIG. 4) in which the first service (e.g., customer service) is operated on the worker node 320 (\textcircled{1} in FIG. 4).

Accordingly, in operation S112, the remote call list for other services (or related services) of the first service may be collected.

As a more specific example, as shown in FIG. 4, the control-plane service 311 may collect the manifest file 230 in which the static analysis result of the deployed first service (e.g., customer service) is stored using a manifest retriever 312 (\textcircled{2} in FIG. 4).

In addition, in operation S113, metadata about the workload in which multiple services constituting the application are operated may be collected in the cloud system, and more specifically, metadata about other services remotely called by the first service may be collected.

As a more specific example, as shown in FIG. 4, the control-plane service 311 may collect metadata (e.g., the name (“cluster.local/ns/default/sa/customer”) in which “customer service” is deployed and operated in FIG. 4) about workloads (321, 322, and 323 in FIG. 4) in which multiple services (e.g., customer service, payment service, or notification service) constituting the application are operated.

Accordingly, as shown in FIG. 4, the control-plane service 311 may generate a first prompt based on the collected remote call list and the metadata and request the artificial intelligence model such as a large language model (LLM) to generate a first security policy corresponding to the first service (\textcircled{3} in FIG. 4).

In response thereto, the artificial intelligence model such as a large language model (LLM) may generate and provide a first security policy corresponding to the first service, based on the first prompt (\textcircled{4} in FIG. 4).

Accordingly, the control-plane service 311 may apply the first security policy to a second workload in which a second service remotely called by the first service is operated, thereby controlling the remote call from the first service (\textcircled{5} in FIG. 4).

As a more specific example, as shown in FIG. 4, the control-plane service 311 may apply the first security policy for the first service (customer service in FIG. 4) to the second workload (322 in FIG. 4) in which the second service (payment service in FIG. 4) remotely called by the first service is operated, thereby controlling the remote call from the first service to block abnormal remote calls.

Subsequently, in operation S120, the first prompt may be configured based on the remote call list.

For example, as shown in FIG. 6, the control-plane service 311 may produce information (e.g., relationships among multiple services, etc.) necessary to generate the security policy, based on the manifest files for the first service, which are collected using the manifest retriever 312, and configure the first prompt by reflecting the same (e.g., “Dev information” in the first prompt 400 in FIG. 6).

In addition, in operation S120, it is also possible to configure the first prompt by also considering the metadata together with the remote call list.

For example, as shown in FIG. 6, the control-plane service 311 may produce information (e.g., the name of the workload generated when multiple services are deployed and operated in a cloud system, the presence or absence of an existing policy file, etc.) necessary to generate the security policy, based on the metadata about the workload in which the multiple services are operated together with the manifest file for the first service, and configure the first prompt by reflecting the same (e.g., “Ops information” in the first prompt 400 in FIG. 6).

Furthermore, in operation S120, the first prompt may be configured by adding some or all of the content of the remote call list and the metadata to a predefined prompt template.

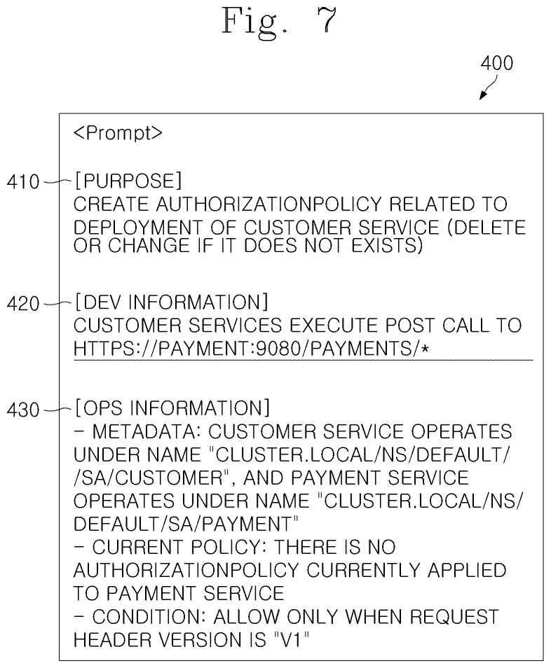

For example, referring to FIG. 7, the first prompt 400 may include a purpose item 410, a development information item 420, and an operation information item 430, and in this case, each item may be configured by adding some content to a pre-defined (hardcoded) template.

More specifically, the purpose item 410 may be configured by adding content such as <target service name> and <deploy|update|delete> to the template “Create AuthorizationPolicy to <deploy|update|delete><target service name>”.

In addition, the development information item 420 may be configured by adding content such as <RPC list on Manifest-URL, path, protocol, and method of each RPC> to the template “<target service name> executes <RPC list on Manifest-URL, path, protocol, and method of each RPC>”.

In addition, the operation information item 430 may be configured by adding content such as <related service name>, <service name on system>, <Policy content>, <key>, and <value> to the template illustrated below.

### [Example of Template Related to Operation Information Item]

“—Metadata: <related service name> is operating under the name of <service name on system>.
   Current policy:
(If an existing policy exists) AuthorizationPolicy currently applied to <related service name> is as follows. \n<Policy content>
(If an existing policy does not exist) There is no AuthorizationPolicy currently applied to <related service name>.
   Condition: Allow only when <key> is <value>.”

In this case, in case that there is a pre-deployed security policy corresponding to the first service, the first prompt may be configured to include the pre-deployed security policy in operation S120, and accordingly, in operation S130, the first security policy may be generated by reflecting the security policy updated according to the update of the first service to the pre-deployed security policy.

Accordingly, in operation S130, the first security policy for the remote call of the first service may be generated using the artificial intelligence model, based on the first prompt.

More specifically, the control-plane service 311 may provide the first prompt 400 configured above to the artificial intelligence model 330 such as a large language model (LLM) to generate the first security policy for the first service.

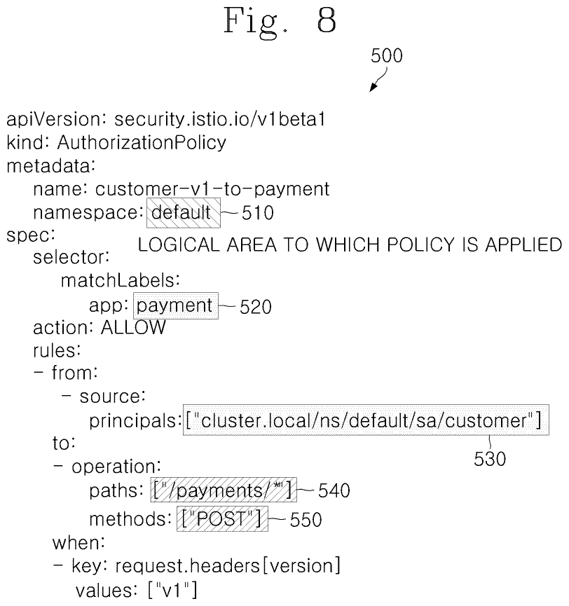

For example, as shown in FIG. 8, the first security policy 500 may be generated in a yaml file format, but the examples are not necessarily limited thereto.

More specifically, as shown in FIG. 8, the generated first security policy 500 may include information 510 about the logical area to which the policy is to be applied, names 520 and 530 of a requesting service and receiving service for the remote call on the cloud system, information 540 and 550 about the path and method to perform the operation, and the like.

In this case, referring to FIG. 8, the first security policy 500 may be configured to include information 540 and 550 that may be produced based on the manifest file derived in the development (Dev) operation, information 510 that may be produced based on the metadata derived in the operation (Ops) operation, and information 520 and 530 that may be produced by considering both pieces of information.

Furthermore, the control-plane service 311 may apply the first security policy to the second workload in which the second service remotely called by the first service is operated, thereby controlling the remote call from the first service.

In this case, in case that the first workload in which the first service is operated is deployed, the control-plane service 311 may deploy and apply the first security policy to the second workload in real time.

As a more specific example, referring to FIG. 6, in case that a first workload 321 in which the first service (e.g., customer service in FIG. 6) is operated is deployed, the control-plane service 311 may generate a first security policy for the first service in real time and apply it to a second workload 322 in which the second service (e.g., payment service in FIG. 6) remotely called by the first service is operated to control remote calls from the first service (customer service), thereby performing access control of blocking remote calls that are determined to be abnormal calls.

Furthermore, as shown in FIG. 6, the first security policy may be applied to a proxy module 322a corresponding to the second workload 322 to control remote calls from other workloads such as the first workload 321, thereby performing access control of blocking abnormal calls.

In addition, a computer program according to another aspect of the embodiments may be a computer program stored in a computer-readable medium for executing a series of operations of the security policy generating method described above in a computer. The computer program may be not only a computer program including machine language codes created by a compiler, but also a computer program including high-level language codes executable in a computer using an interpreter or the like. In this case, the computer includes, in addition to a personal computer (PC) or a laptop computer, any type of information processing device equipped with a central processing unit (CPU) to execute a computer program, such as a server, a smartphone, a tablet PC, a PDA, or a mobile phone.

In addition, the computer-readable medium may be a medium that continuously stores a computer-executable program, or temporarily stores it for execution or download. In addition, the medium may be a variety of recording means or storage means in the form of a single piece of hardware or a combination of multiple pieces of hardware, and may not be limited to a medium directly connected to a computer system, but may also be distributed on a network. Therefore, the above detailed description should not be construed as limiting the disclosure in all respects and should be considered as examples. The scope of the disclosure should be determined by a reasonable interpretation of the appended claims, and all changes within the equivalent scope of the disclosure are included in the scope of the disclosure.

In addition, a security policy generating apparatus 120, in accordance with one or more embodiments, is an apparatus that automatically generates a communication among multiple services constituting an application running in a cloud system, which may include: one or more processors; and memories, wherein the memories may include instructions configured to, when executed by the one or more processors, cause the apparatus to implement specific operations, and the specific operations may include: collecting an application programming interface (API) remote call list for other services of a first service among the multiple services; configuring a first prompt, based on the remote call list; and generating a first security policy for a remote call of the first service using an artificial intelligence model, based on the first prompt.

Here, the specific operations may further include generating the application programming interface (API) remote call list for other services through static analysis of source code of the first service.

In addition, the collecting may include deploying a first workload in which the first service is operated; collecting a remote call list for other services of the first service; and collecting metadata about a workload in which the multiple services are operated in the cloud system.

In addition, in the collecting, metadata about other services remotely called by the first service may be collected.

In addition, the specific operations may further include applying the first security policy to a second workload in which a second service remotely called by the first service is operated, thereby controlling a remote call from the first service.

In this case, in case that the first workload in which the first service is operated is deployed, the first security policy may be deployed and applied to the second workload in real time.

In addition, the first security policy may be applied to a proxy module corresponding to the second workload.

In addition, in the configuring, the first prompt may be configured by adding some or all of the content of the remote call list and the metadata to a predetermined prompt template.

In addition, in the configuring, in case that there is a pre-deployed security policy corresponding to the first service, the first prompt may be configured such that the pre-deployed security policy is included in the first prompt, and in the generating, the first security policy may be generated by reflecting the updated security policy according to the update of the first service to the pre-deployed security policy.

In addition, FIG. 9 illustrates a device 50 to which the proposed method of the disclosure may be applied.

Referring to FIG. 9, the device 50 may be configured to implement a security policy generation process according to the proposed method of the disclosure.

For example, the device 50 to which the proposed method of the disclosure may be applied may include network devices such as repeaters, hubs, bridges, switches, routers, gateways, and the like, computer devices such as desktop computers, workstations, and the like, mobile terminals such as smartphones and the like, portable devices such as laptop computers and the like, home appliances such as digital TVs and the like, and moving devices such as vehicles and the like. As another example, the device 50 to which the disclosure may be applied may be included as part of an ASIC (Application Specific Integrated Circuit) implemented in the form of an SoC (System-on-Chip).

The methods illustrated in, and discussed with respect to, FIGS. 1-9 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The memory 20 may be connected to the processor 10 during operation, and may store programs and/or instructions for processing and controlling the processor 10, and may store data and information used in the disclosure, control information required for processing data and information according to the disclosure, and temporary data generated during the data and information processing process.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

The processor 10 may be operatively connected to the memory 20 and/or the network interface 30, and may control the operation of respective modules in the device 50. In particular, the processor 10 may perform various control operations to perform the proposed method of the disclosure. The processor 10 may also be called a controller, a micro-controller, a micro-processor, a micro-computer, or the like. The proposed method of the disclosure may be implemented by hardware, firmware, software, or a combination thereof. When implementing the disclosure using hardware, an ASIC (application specific integrated circuit) or a DSP (digital signal processor), a DSPD (digital signal processing device), a PLD (programmable logic device), an FPGA (field programmable gate array), or the like, configured to perform the disclosure, may be provided in the processor 10. Meanwhile, when implementing the proposed method of the disclosure using firmware or software, the firmware or software may include instructions related to modules, procedures, or functions that perform functions or operations necessary for implementing the proposed method of the disclosure, and the instructions may be stored in the memory 20 or stored in a computer-readable recording medium (not shown) separate from the memory 20, and may be configured to cause, when executed by the processor 10, the device 50 to perform the proposed method of the disclosure.

In addition, the device 50 may include a network interface device 30. The network interface device 30 may be connected to the processor 10 during operation, and the processor 10 may control the network interface device 30 to transmit or receive wireless/wired signals carrying information, data, signals, and/or messages through a wireless/wired network. The network interface device 30 may support various communication standards such as IEEE 802 series, 3GPP LTE(-A), 3GPP 5G, etc., and may transmit and receive control information and/or data signals according to the corresponding communication standards. The network interface device 30 may be implemented outside the device 50 as needed.

Accordingly, a method, apparatus, system, and computer program for generating an inter-service communication security policy according to an embodiment of the disclosure may effectively identify the relationships among multiple services constituting an application and write and apply a security policy to suppress security risks, and may further effectively resolve the security operation difficulties and security risks of the operator due to the addition, deletion, and update of multiple services.

The embodiments described in this specification and the attached drawings are merely examples and do not limit the scope of the disclosure in any way. In addition, the connections or connection members between the components illustrated in the drawings are examples of functional connections and/or physical or circuit connections, and may be represented as various operational connections, physical connections, or circuit connections that are replaceable or addible in an actual device. In addition, unless specifically stated with “essential”, “important”, etc., the components may not be essential for the application of the disclosure.

In the specification (especially, in the claims) of the present disclosure, the term “said” and indicative terms similar thereto may be used for both a single element or multiple elements. In addition, in case that a range is stated in the disclosure, it encompasses embodiments to which respective values within the range are applied (unless otherwise stated), and the respective values constituting the range are regarded as being described in the detailed description of the disclosure. In addition, the operations presented in the method of the disclosure are not intended to be restricted in their sequence, and the sequence thereof may be appropriately changed as needed, unless a certain step must precede according to the nature of the process. All examples or the use of example terms (e.g., etc.) in the disclosure is merely intended to describe the disclosure in detail, and the scope of the disclosure is not limited to the examples or example terms, unless limited by the claims. In addition, those skilled in the art will understand that various modifications, combinations, and changes may be configured according to design conditions and elements without departing from the scope of the appended claims or their equivalents.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method that automatically generates a communication security policy among multiple services constituting an application running in a cloud system with a computing device, the method comprising:
collecting an application programming interface (API) remote call list for related services of a first service among the multiple services;
configuring a first prompt, based on the remote call list; and
generating a first security policy for a remote call of the first service by implementing an artificial intelligence model, based on the first prompt.

2. The method of claim 1,
further comprising generating the application programming interface (API) remote call list for the related services by performing static analysis of source code of the first service.

3. The method of claim 1,
wherein the collecting comprises:
deploying a first workload in which the first service is operated;
collecting the remote call list for the related services of the first service; and
collecting metadata about a workload in which the multiple services are operated in the cloud system.

4. The method of claim 1,
wherein the collecting comprises collecting metadata about related services that are remotely called by the first service.

5. The method of claim 1,
further comprising applying the first security policy to a second workload in which a second service that is remotely called by the first service is operated, to control a remote call from the first service.

6. The method of claim 5,
further comprising deploying and applying the first security policy to the second workload in real time when the first workload in which the first service is operated is deployed.

7. The method of claim 5,
further comprising applying the first security policy to a proxy device corresponding to the second workload.

8. The method of claim 1,
wherein the configuring of the first prompt comprises adding some or all of the content of the remote call list and the metadata to a predetermined prompt template, to configure the first prompt.

9. The method of claim 1,
wherein the configuring of the first prompt comprises:
configuring the first prompt such that the pre-deployed security policy is included in the first prompt when there is a pre-deployed security policy corresponding to the first service,
wherein the generating of the first security policy comprises generating the first security policy by reflecting an updated security policy according to an update of the first service to the pre-deployed security policy.

10. An apparatus that automatically generates a communication security policy among multiple services constituting an application running in a cloud system, the apparatus comprising:
one or more processors; and
a memory storing instructions that, when executed by the one or more processors cause the apparatus to:
collect an application programming interface (API) remote call list for related services of a first service among the multiple services;
configure a first prompt, based on the remote call list; and
generate a first security policy for a remote call of the first service by implementing an artificial intelligence model, based on the first prompt.

11. The apparatus of claim 10,
wherein the one or more processors are further configured to generate the application programming interface (API) remote call list for the related services by performing static analysis of source code of the first service.

12. The apparatus of claim 10,
wherein the collecting comprises:
deploying a first workload in which the first service is operated;
collecting the remote call list for the related services of the first service; and
collecting metadata about a workload in which the multiple services are operated in the cloud system.

13. The apparatus of claim 10,
wherein, in the collecting, metadata about related services that are remotely called by the first service are collected.

14. The apparatus of claim 10,
wherein the specific operations further comprise applying the first security policy to a second workload in which a second service that is remotely called by the first service is operated, to control a remote call from the first service.

15. The apparatus of claim 14,
wherein, the first security policy is deployed and applied to the second workload in real time when the first workload in which the first service is operated is deployed.

16. The apparatus of claim 14,
wherein the first security policy is applied to a proxy device corresponding to the second workload.

17. The apparatus of claim 10,
wherein, in the configuring of the first prompt, the first prompt is configured by adding some or all of the content of the remote call list and the metadata to a predetermined prompt template.

18. The apparatus of claim 10,
wherein, in the configuring of the first prompt,
the first prompt is configured such that the pre-deployed security policy is included in the first prompt when there is a pre-deployed security policy corresponding to the first service, and
wherein, in the generating of the first security policy, the first security policy is generated by reflecting an updated security policy according to an update of the first service to the pre-deployed security policy.

19. A non-transitory computer-readable storage medium storing instructions that, when executed by one or more processors, cause an apparatus that automatically generates a communication security policy among multiple services constituting an application running in a cloud system, to:
collect an application programming interface (API) remote call list for related services of a first service among the multiple services;
configure a first prompt, based on the remote call list; and
generate a first security policy for a remote call of the first service by implementing an artificial intelligence model, based on the first prompt.

20. The non-transitory computer-readable storage medium of claim 19,
wherein the one or more processors are further configured to generate the application programming interface (API) remote call list for the related services by performing static analysis of source code of the first service.
